(19) United States
(12) Patent Application Publication
(10) Pub. No.: US 2011/0132858 A1
(43) Pub. Date: Jun. 9, 2011

(54) FINIAL ASSEMBLIES

(76) Inventor: Charles Edward Webster-Smith, Hertfordshire (GB)

(21) Appl. No.: 12/996,037

(22) PCT Filed: Jun. 3, 2009
(86) PCT No.: PCT/GB2009/001384

§ 371 Date: Dec. 3, 2010

(30) Foreign Application Priority Data
Jun. 3, 2008 (GB) 0810099.2

(51) Int. Cl. A47H 1/02; B44C 5/00; A47H 1/00

(52) U.S. Cl. 211/123; 428/28

(57) ABSTRACT

A finial assembly which includes a member (1) which is for providing ornamental and/or decorative effect and which is retained threaded on a pole or rod (3) in abutment with a cap (6) that is secured to the rod (3) covering the rod-end (5). A ring (4), threaded on the rod (3), is secured to the rod (3) in abutment with the member (1) to clamp the member (1) between the ring (4) and the cap (6). Finial assemblies which each involve more than one ornamental-decorative member (21-23) clamped between an end-cap (26) and retaining ring (25), may be provided at either end of a curtain rod (24). Variation of finial-effect can be simply achieved by changing the ornamental-decorative members (21-23, 27), or their order, on the rod (24).

This application is a national stage completion of PCT/GB2009/001384 filed Jun. 3, 2008 which claims priority from Great Britain Application Serial No. 081099.2 filed Jun. 3, 2008.

### FIELD OF THE INVENTION

This invention relates to finial assemblies.

### BACKGROUND OF THE INVENTION

Finials are used most commonly for ornamental and/or decorative effect at the ends of curtain rods or poles, but find application more-generally for the same effect in furnishings and furniture, for example on the head- and foot-ends of beds.

In a general context, a finial has the form of a boss or knob that incorporates ornamental and/or decorative features and commonly has a socket by which it can be mounted and secured, usually to a projecting end of a rod, pole or other support. For example, a curtain-rod finial commonly has a socket which receives the end of the curtain rod and is secured in assembly with the rod by means of a fixing screw that is screwed from the boss to impinge on the rod within the socket.

### SUMMARY OF THE INVENTION

It is one of the objects of the present invention to provide a form of finial assembly that enables a greater range of ornamental and/or decorative effect to be achieved with economy, than with known finials.

According to the present invention there is provided a finial assembly wherein a member for providing ornamental and/or decorative effect is threaded onto a support and is retained there between two fittings that are secured to the support at spaced positions from one another on the support, retention of said member between the two fittings being by abutment with them.

The member specified for providing ornamental and/or decorative effect in the finial assembly of the invention may provide this by colour, colour combination, shape and/or configuration, and may be retained on the support by abutment of it directly with both fittings.

According to a feature of the present invention there is provided a finial assembly wherein a plurality of members each of which is for providing ornamental and/or decorative effect, are threaded onto the support and are retained there between two fittings that are secured to the support at spaced positions from one another on the support, retention of said members between the two fittings being by mutual abutment and sandwiching of them between the two fittings.

The support of the finial assembly of the invention may be a rod or pole, and in this case at least one of the fittings may be a ring threaded onto the rod or pole, and where just one of the fittings is a ring the other may be a cap for retention covering an end of the rod or pole.

A finial assembly according to the invention may be provided at both ends of a curtain rod or pole.

### BRIEF DESCRIPTION OF THE DRAWINGS

Examples of finial assemblies in accordance with the present invention will now be described with reference to the accompanying drawings, in which:

FIG. 1 is a side view partly in longitudinal section, of a finial assembly in accordance with the invention;

FIG. 2 is an exploded perspective view of the finial assembly of FIG. 1;

FIG. 3 is a side view of a curtain rod having finial assemblies in accordance with the invention at both ends; and

FIG. 4 is a side view of a further finial assembly in accordance with the invention.

### DETAILED DESCRIPTION OF THE DRAWINGS

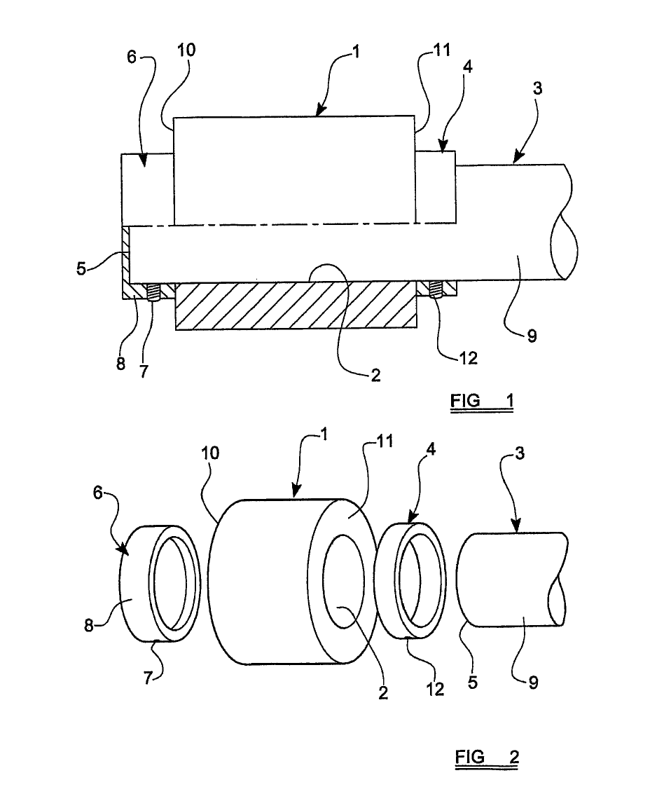

The finial assembly of FIGS. 1 and 2 is for providing ornamental and decorative termination to one end of a supporting curtain rod or pole. An identical finial assembly will in normal circumstances terminate the other end of the curtain rod or pole.

Referring to FIGS. 1 and 2, a boss or knob member 1 having a cylindrical, axial bore 2 is threaded onto the cylindrical curtain-rod 3 to provide the principal ornamental and decorative effect of the finial assembly. The member 1 is mounted on the rod 3 in this way following the threading onto the rod 3 of a retaining ring 4 and before the free end 5 of the rod 3 is capped by a retaining end-cap 6. The cap 6 is secured covering the rod-end 5 by means of a screw 7. In this regard, the screw 7 is screwed into a tapped hole through the cylindrical rim 8 of the cap 6 to impinge on the cylindrical surface 9 of the rod 3 so as to clamp the cap 6 tightly to the rod 3.

Fitting of the finial assembly continues following clamping of the end-cap 6 to the rod 3, with sliding of the boss or knob member 1 back along the rod 3 to bring a flank 10 of the member 1 into direct abutment with the rim 9 of the secured end-cap 6. The retaining ring 4 is now slid along the rod 3 to bring it into direct abutment with the other flank 11 of the member 1, and a screw 12 that is screwed into a tapped hole of the ring 4, is then tightened onto the surface 9 of the rod 3. This secures the retaining ring 4 clamped to the rod 3 with the member 1 clamped between it and the cap 6.

The fact that the securing of the ornamental and decorative boss or knob member 1 to the rod 3 is achieved independently of any requirement for the member 1 itself to involve screw of other means of fixing to the rod 3, has significant advantages. In particular it reduces the cost of providing the member 1 and does not impose material constraints on its shape and configuration. More especially, it allows a greater freedom of ornamental and decorative expression. Also, although the separate fittings (namely the ring 4 and cap 6) by which fixing is achieved through abutment, may have features of colour, colour combination, shape and/or configuration that contribute to the overall effect, they can have a basic, minimal form that may be independent of the particular ornamental and decorative character of the member 1 with which they are used. They can therefore in this latter regard have a universal applicability that allows them to be mass-produced economically. Thus, the finial assembly of the present invention gives a greater ornamental and decorative freedom than is achievable with known finials, together with readily-realisable cost advantages.

The member 1 is illustrated in FIGS. 1 and 2 as of a generally cylindrical form, but its shape and configuration may vary from this significantly to give virtually any desired ornamental and decorative effect desired; colour or colour combinations may be used to enhance the effect. Clearly, it need not have the solid form illustrated, the basic requirement being that it can be threaded onto the rod 3 and held in place by abutment with the cap 6 and ring 4; it may, for example, have a hollow, open-tracery or woven structure supported on a central collar or collars for threading it onto the rod 3.

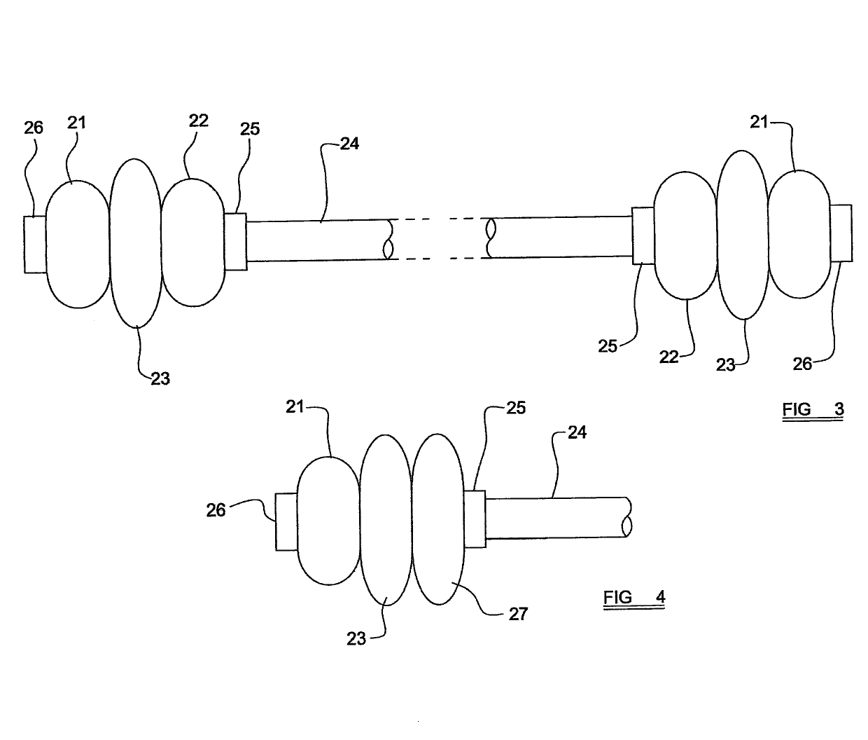

A variety of shapes and configurations of the member 1 may be made available for use as a simple matter of choice. Furthermore these varied shapes may be provided in a variety of colours and combinations of colours. Moreover, it is readily possible to provide the finial assembly with not just one ornamental and decorative member, but with a combination of a plurality of them, in order to enhance the effect. By way of an example of this, a curtain rod according to the invention with finial assemblies at either end which each involve a combination of three such members is illustrated in FIG. 3, and will now be described.

Referring to FIG. 3, each finial assembly of this example involves two boss or knob members 21 and 22 of a truncated-spherical form, and another member 23 having the form of a disc of substantially-elliptical cross-section, located between them. The three members 21 to 23 of each assembly are threaded in the required order onto a respective end of a curtain pole 24, and are retained on it between a retaining ring 25 and an end-cap 26 (which correspond respectively to the ring 4 and end-cap 6 of the finial assembly of FIGS. 1 and 2). The ring 25 and end-cap 26 are secured to the rod 24 by screws (not shown but corresponding to the screws 12 and 7 of FIGS. 1 and 2), with the members 21 and 22 abutting the cap 26 and ring 25 respectively, and the member 23 sandwiched in abutment between them.

An alternative configuration of finial assembly is illustrated in FIG. 4, this being a variation from those shown in FIG. 3 in the omission of the member 22 and replacement of it by a further disc member 27 corresponding to the member 23.

The versatility of the finial assembly of the present invention for easy adaptation and change of ornamental and decorative effect is illustrated, and will now be described by way of simple example, with reference to change of the finial assembly at one end of the rod 24 from the configuration of FIG. 3 to that of FIG. 4.

The change from the configuration of FIG. 3 to that of FIG. 4 is readily made by releasing the end-cap 26 from the relevant end of the rod 24, withdrawing the members 21 to 23 from that end, and replacing the members 23 and 21 (in that order) after a member 27 has been threaded onto the rod 24 at that end. The assembly is consolidated by releasing the ring 25 at that same end and sliding it along the rod 24 so as to bring it hard onto the member 27 in order to close up the members 21, 23 and 27 into abutment with one another and the member 21 into abutment with the cap 26. The ring 25 is then secured again, abutting the member 27.

Instead of changing from the configuration of FIG. 3 to that of FIG. 4, a change of decorative effect could also be readily achieved, simply by changing the order with which the members 21-23 are threaded on the rod 24.

Although the invention has been described above in the context of finial assemblies for termination of the projecting ends of curtain rods or poles, it has wider application. For example, it may be applied to termination of the upwardly-projecting posts of head- and foot-ends of beds. Furthermore, assemblies in accordance with the invention may, for example, be provided for ornamental and/or decorative effect at intermediate locations along curtain or other rods. In this latter regard, the assemblies described above with reference to FIGS. 1 to 4 may be used in intermediate locations on a rod simply by replacing the cap-ends 6 and 26 by ring-fittings corresponding to the rings 4 and 25.

1-11. (canceled)

12. A finial assembly for providing an ornamental decorative effect on an elongate support, the finial assembly comprising:
an ornamental decorative component threaded onto the elongate support, and two fittings secured to the elongate support at spaced locations from one another lengthwise of the elongate support,
wherein the two fittings are located on the elongate support on opposite sides from one another of the ornamental decorative component, and the two fittings retain the ornamental decorative component located on the elongate support between the two fittings by abutment thereof respectively with the opposite sides of the ornamental decorative component.

13. The finial assembly according to claim 12, wherein the ornamental decorative component comprises a plurality of mutually abutting ornamental decorative members threaded onto the elongate support.

14. The finial assembly according to claim 12, wherein each of the two fittings abut the ornamental decorative component directly.

15. The finial assembly according to claim 12, wherein the elongate support is one of a rod and a pole.

16. The finial assembly according to claim 15, wherein at least one of the two fittings is a ring threaded onto one of the rod and the pole.

17. The finial assembly according to claim 15, wherein one of the two fittings is a cap retained covering an end of one of the rod and the pole.

18. A finial assembly for providing ornamental and/or decorative effect on an elongate support, the finial assembly comprising:
a plurality of ornamental decorative components threaded onto the elongate support mutually abutting one another, and
two fittings secured to the elongate support at spaced locations from one another lengthwise of the elongate support,
wherein the two fittings are located on the elongate support on opposite sides of the mutually-abutting ornamental decorative components for retention of the mutually-abutting ornamental decorative components on the elongate support sandwiched between the two fittings.

19. The finial assembly according to claim 18, wherein the elongate support is one of a rod and a pole,

20. The finial assembly according to claim 19, wherein at least one of the two fittings is a ring threaded onto one of the rod and the pole.

21. The finial assembly according to claim 18, wherein at least one of the two fittings is a ring secured to the elongate support.

22. The finial assembly according to claim 18, wherein one of the two fittings is a cap retained covering an end of the elongate support.

23. The finial assembly according to claim 22, wherein the cap is secured to one of the rod and the pole by a screw that impinges on a surface of said one of a rod and a pole.

24. A curtain hanger comprising an elongate support for at least one curtain, the elongate support having two ends, and two finial assemblies attached to the two ends respectively of the elongate support to provide ornamental and/or decorative effect at the two ends, each finial assembly comprising:
at least one ornamental decorative component threaded onto a respective one of the two ends of the elongate support, and
two fittings secured to the respective one of the two ends of the elongate support at spaced locations from one another lengthwise of the elongate support,
wherein the two fittings are located on the respective one of the two ends of the elongate support in abutment with opposite sides of the ornamental decorative component in retention of the ornamental decorative component on the elongate support sandwiched between the two fittings.

25. The curtain hanger according to claim 24, wherein one of the two fittings of each finial assembly is a ring threaded onto the elongate support.

26. The curtain hanger according to claim 24, wherein one of the two fittings of each finial assembly is an end-cap attached to the respective one of the two ends of the elongate support.

27. The curtain hanger according to claim 24, wherein the elongate support is one of a rod and a pole.
